(19) United States
(12) Patent Application Publication
(10) Pub. No.: US 2026/0038246 A1
(43) Pub. Date: Feb. 5, 2026

(54) Stabilizing GAN Training by Regulating Learning Rates in Semiconductor Workpiece Inspection Models

(71) Applicant: Wolfspeed, Inc., Durham, NC (US)

(72) Inventors: Matthew David Conrad, Cary, NC (US); Edward Robert Van Brunt, Cary, NC (US)

(21) Appl. No.: 18/789,165

(22) Filed: Jul. 30, 2024

(51) Int. Cl. G06V 10/774; G06T 7/00; G06V 10/77

(52) U.S. Cl. CPC G06V 10/774; G06T 7/0004; G06V 10/7715; G06T 2207/10061; G06T 2207/10116; G06T 2207/20081; G06T 2207/20084; G06T 2207/30148; G06T 2207/30164; G06V 2201/06

(57) ABSTRACT

Systems and methods for inspecting semiconductor workpieces are provided. In one example, a method includes obtaining workpiece data for a semiconductor workpiece. The method includes providing the workpiece data as input to an inspection model, the inspection model being a stabilized learning generative adversarial network (SLGAN) trained model, wherein the SLGAN trained model is associated with a regulated learning rate for one or more of a discriminator network or a generator network. The method also includes obtaining an output from the inspection model, the output associated with one or more characteristics of the semiconductor workpiece.

### FIELD

The present disclosure relates generally to manufacturing semiconductor devices.

### BACKGROUND

Semiconductor devices can be fabricated from workpieces of semiconductor material, such as silicon, sapphire, silicon carbide (SiC), and many others. These materials exhibit many attractive electrical and thermophysical properties, making it suitable for the fabrication of workpieces or substrates for high power density solid state devices, such as power electronic, radio frequency, and optoelectronic devices. During manufacturing, these materials may have crystalline material features at multiple length scales, from workpiece-sized features down to micron-scale features or sub-micron scale features (e.g., nanometer scale features). It may be desirable to detect and characterize the features during device manufacturing.

### SUMMARY

Aspects and advantages of embodiments of the present disclosure will be set forth in part in the following description, or can be learned from the description, or can be learned through practice of the embodiments.

One example aspect is directed to a method. The method includes obtaining workpiece data for a semiconductor workpiece. The method includes providing the workpiece data as input to an inspection model, the inspection model being a stabilized learning generative adversarial network (SLGAN) trained model, wherein the SLGAN trained model is associated with a regulated learning rate for one or more of a discriminator network or a generator network. The method also includes obtaining an output from the inspection model, the output associated with one or more characteristics of the semiconductor workpiece.

Another example aspect of the present disclosure is directed to a method. The method includes conducting a first training epoch for a generative network and determining a first loss for the generative network. The method includes conducting a second training epoch for a discriminator network and determining a second loss for the discriminator network. The method includes regulating a learning rate for one or more of the generative network or the discriminator network based at least in part on the first loss for the generative network and the second loss for the discriminator network.

Another example aspect of the present disclosure is directed to a system. The system includes one or more imaging devices configured to capture image data of at least a portion of the semiconductor workpiece and processing circuitry configured to perform operations. The operations may include providing workpiece data as input to an inspection model, the inspection model being a generative adversarial network (GAN) trained model the GAN trained model is associated with a regulated learning rate for one or more of a discriminator network or a generator network. The operations may also include obtaining an output from the inspection model, the output associated with one or more characteristics of the semiconductor workpiece.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts example systems and methods for inspecting semiconductor workpieces according to example aspects of the present disclosure.

FIG. 2 depicts example systems and methods for inspecting semiconductor workpieces according to examples aspects of the present disclosure.

FIG. 3 depicts example systems and methods for inspecting semiconductor workpieces according to examples aspect of the present disclosure.

FIG. 4 depicts example systems and methods for inspecting semiconductor workpieces according to examples aspect of the present disclosure.

FIG. 5 depicts a flow diagram of an example method for training an SLGAN according to example aspects of the present disclosure.

FIG. 6A depicts a XY plot of traditional generative adversarial network losses, both discriminator network loss and generator network loss, over a plurality of epochs.

FIG. 6B depicts a set of validation images used for evaluating a discriminator network of a GAN according to traditional methods of GAN training.

FIG. 6C depicts a set of generated images used for evaluating a discriminator network of a GAN according to traditional methods of GAN training.

FIG. 7A depicts a XY plot of stabilized learning generative adversarial network loss over a plurality of epochs according to examples aspects of the present disclosure.

FIG. 7B depicts a set of target images used for training a GAN according to example aspects of the present disclosure.

FIG. 7C depicts a set of generated images used for evaluating a discriminator network of a GAN according to example aspects of the present disclosure.

FIG. 7D depicts an example image comparison between a target image and a generated image from a traditional GAN and an SLGAN according to example aspects of the present disclosure.

FIG. 8 depicts a flow diagram of an example method according to example aspects of the present disclosure.

FIG. 9 depicts a flow diagram of an example method according to example aspects of the present disclosure.

FIG. 10 depicts a block diagram of an example computing system that can be used to implement systems and methods according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Power semiconductor devices are often fabricated from wide bandgap semiconductor materials, such as silicon carbide or Group III-nitride based semiconductor materials (e.g., gallium nitride). Herein, a wide bandgap semiconductor material refers to a semiconductor material having a bandgap greater than 1.40 eV. Aspects of the present disclosure are discussed with reference to silicon carbide-based semiconductor structures as wide bandgap semiconductor structures. Those of ordinary skill in the art, using the disclosures provided herein, will understand that example embodiments of the present disclosure may be used with any semiconductor material, such as other wide bandgap semiconductor materials, without deviating from the scope of the present disclosure. Example wide bandgap semiconductor materials include silicon carbide and the Group III-nitrides.

Power semiconductor devices may be fabricated using epitaxial layers formed on a semiconductor workpiece, such as a silicon carbide semiconductor wafer. Example semiconductor workpieces may include or be formed of one or more crystalline semiconductor materials, such as silicon, silicon carbide, sapphire, or other suitable materials. The semiconductor workpiece may be subjected to various fabrication processes to form semiconductor devices on the semiconductor workpiece. Examples fabrication process may include, for instance, surface processing operations (e.g., grinding, lapping, polishing), epitaxial growth processes, deposition, etching, annealing, implantation, surface treatment, and/or other processes to form semiconductor devices on the semiconductor workpiece. Example fabrication processes include both workpiece fabrication processes (e.g., fabricating semiconductor workpieces, such as silicon carbide semiconductor wafers) as well as various stages of semiconductor device fabrication on semiconductor workpieces (e.g., MOSFETs, Schottky diodes, HEMTs, IGBTs, etc.).

Aspects of the present disclosure are discussed with reference to a semiconductor workpiece that is a semiconductor wafer that includes silicon carbide (“silicon carbide semiconductor wafer”) for purposes of illustration and discussion. Those of ordinary skill in the art, using the disclosures provided herein, will understand that aspects of the present disclosure can be used with other semiconductor workpieces. Other semiconductor workpieces may include carrier substrates, ingots, boules, polycrystalline substrates, monocrystalline substrates, bulk crystalline material having a thickness of greater than about 1 mm, such as greater than about 5 mm, such as greater than about 10 mm, such as greater than about 20 mm, such as greater than about 50 mm, such as greater than about 100 mm, to 200 mm, etc.

In some examples, the semiconductor workpiece includes silicon carbide crystalline material. The silicon carbide crystalline material may have a 4H crystal structure, 6H crystal structure, or other crystal structure. The semiconductor workpiece can be an on-axis workpiece (e.g., end face parallel to the (0001) plane) or an off-axis workpiece (e.g., end face non-parallel to the (0001) plane), such as a 2°, 4°, 6°, or 8° off-axis workpiece.

Aspects of the present disclosure may make reference to a surface of the silicon carbide semiconductor workpiece. In some examples, the surface of the workpiece may be, for instance, a silicon face of the workpiece. In some examples, the surface of the workpiece may be, for instance, a carbon face of the workpiece.

Crystalline material features can be introduced during the manufacturing process of the semiconductor workpiece, such as silicon carbide semiconductor workpieces. These features can range in width scale from nearly workpiece-size features to micron or sub-micron features (e.g., nanometer scale features). Example features may include crystalline material features, such as threading edge dislocations, basal plan dislocations, super screw dislocations, micropipes, mixed dislocations, hexagonal voids, stacking faults, scratches, other polytypes, contamination, and other features. In certain examples, the feature width is less than or equal to about 10 microns. In certain examples, the feature width is less than or equal to about 3 microns. In certain examples, the feature width is in a range of about 1 micron and 25 microns. In certain examples, the feature width is less than 1 micron, such as in a range of about 1 nanometer to about 900 nanometers. As used herein, a “feature width” refers to a smallest dimension in the positional coordinate plane in an image of the workpiece. Because of the significant variety of potential features and the range of potential sizes or lengths of features, it can be challenging to characterize and inspect the features of semiconductor workpieces at scale.

Certain metrology solutions may be able to detect features, such as individual micropipes, basal plane dislocation, scratches, etc., using high resolution semiconductor workpiece imaging (e.g., about 1 to about 10 microns per pixel). However, these types of features may not occur at random, but rather may have specific spatial distributions based on crystal growth and workpiece processing issues or anomalies. Classifying and detecting feature distributions in semiconductor workpieces may provide more accurate information to accelerate crystal growth and workpiece technology process development. Furthermore, as crystal growth and semiconductor workpiece processing technologies evolve, new features and feature distributions may arise that are not adequately detected by prior techniques.

Accordingly, example aspects of the present disclosure provide systems and methods for inspection and characterization of semiconductor workpiece features. For instance, systems and methods according to some example aspects of the present disclosure may obtain workpiece data associated with a semiconductor workpiece and detect one or more features associated with the semiconductor workpiece using a stabilized learning generative adversarial network (SLGAN) trained inspection model. Additionally, in some implementations, the one or more features may be detected during a fabrication process that, based on the detected one or more features, may be modified, halted, or otherwise reconfigured.

To detect one or more features associated with a semiconductor workpiece, data associated with the semiconductor workpiece may be provided to a computer implemented model (e.g., inspection model). In some examples, the computer-implemented model includes one or more machine learned models trained, at least in part, with an SLGAN. Various SLGAN trained machine-learned models may be incorporated into the inspection model such as autoencoder models, image translation models, feature detection models, computer vision models, and/or any other machine learned model(s) which may assist in or perform inspection of semiconductor workpieces.

In some instances, the SLGAN may include one or more networks (e.g., neural networks) trained with regulated learning rates. A generative adversarial network (GAN) may include a discriminator network and a generator network that train based on the output of each other. The discriminator network and/or the generator network may be neural networks, such as deep neural networks, in some examples. Referring to the SLGAN, the learning rate associated with either network, the generative network or the discriminator network, may be regulated to stabilize the overall learning rate of the SLGAN. In some examples, the respective learning rates of the two networks may be individually regulated to optimally train each network and stabilize the overall loss of the SLGAN during training.

The learning rates associated with the neural networks within the SLGAN may be regulated in a variety of methods and forms. In some instances, the learning rates of the neural networks may be regulated based on an adversarial ratio. The adversarial ratio may be based on a ratio of the loss associated with a generator network relative to the loss associated with a discriminator network. The adversarial ratio may be monitored in accordance with one or more threshold values (e.g., thresholds) to modify the learning rate of one or more of the neural networks within the SLGAN, such as the discriminator network or the generator network. For example, the adversarial ratio may be monitored in relation to a threshold of 1.0 such that, if the adversarial ratio goes above or below the threshold, one or more gradients of the generative network or the discriminator network may be frozen relative to the other (e.g., discriminator network gradients frozen relative to the generator network gradients) until the adversarial ratio crosses back over the threshold.

In some examples, the SLGAN trained model within the inspection model may be an autoencoder model including an encoding portion and a decoding portion, each with one or more machine-learned models. Any input to the inspection model may be provided to the encoding portion of the autoencoder model to generate an encoding of the input. The encoding model can be any suitable encoding or encoder model. An encoding model can receive various types of input (e.g., image data, alphanumerical data, etc.) and, in response to receipt of the input data, produce an encoding as output. The encoding can be a representation of the input variables in a machine-encoded format (e.g., a numerical format). In some examples, the encoding may not be human-readable. However, characteristics and trends among the input data may be represented in characteristics of the encoding. In particular, the encoding model can be trained to produce encodings that represent characteristics of the input data by training the encoding model end-to-end with a decoding or decoder model. For instance, in some examples, the encoding of the input workpiece data may be indicative of one or more features, feature distributions, anomalies, or similarities of the semiconductor workpiece.

The decoding model can be configured to receive an encoding as input and, in response to receipt of the encoding as input, produce output in a human-intelligible or other suitable format, such as image data, alphanumerical data, classification data, or other suitable data. In some implementations, such an arrangement may be referred to as an “autoencoder.” However, in some implementations, the encoding model and decoding model may not necessarily be related or be part of a common model schema such as an autoencoder. For instance, the encoding model and the decoding model may be independent models having separate networks (e.g., neural networks). In some examples, the encoding model may be any suitable machine learned model that is trained to produce encoding that represents input data. The model can have any number of parameters without deviating from the scope of the present disclosure. The model can have various model architectures (e.g., any number convolutional layers, transformer layers, etc.) without deviating from the scope of the present disclosure.

In some implementations, the autoencoder model may be trained, at least in part, using the SLGAN. For instance, the decoding portion of the autoencoder (e.g., decoding model) may be trained using the discriminator network of the SLGAN. In some examples, the decoding portion may be configured to generate a target image based on a provided encoding input (e.g., the encoding from the encoding portion of the autoencoder). The discriminator network within the SLGAN may be used to train the decoding portion of the autoencoder to generate better target images by taking the output of the decoding portion as input and providing feedback data to the decoding portion. As a result, based on the complementary nature of the autoencoding model, the encoding portion of the autoencoder model may receive improved feedback and training from the decoding portion based on the improved feedback and training of the decoding portion from the SLGAN. Further, in some embodiments, the final output of the inspection model may be an encoding from the encoder portion of the SLGAN trained autoencoder model. In these embodiments, the encoding may be indicative of one or more characteristics of a semiconductor workpiece from which workpiece data is received, such as a similarity or anomaly of the semiconductor workpiece.

To provide for outputting encodings that reflect the characteristics of the semiconductor workpieces, the method can include training the machine-learned encoding model on a batch of training data. The training data can include input data corresponding to one or more additional semiconductor workpieces. The training data can include, for example, workpiece images, residual images, crop coordinates, and/or additional inputs for the additional semiconductor workpieces. In some implementations, the machine-learned encoding model can be trained end-to-end with a machine-learned decoding model. For instance, the machine-learned decoding model can be a decoding network having a separate neural network from the machine-learned encoding model. In some instances, the decoding network may be trained using the discriminator network of an SLGAN. The SLGAN may provide feedback data of the decoding network's output to the decoding network during training. Additionally or alternatively, the encoding model can be an encoder portion of an autoencoder (e.g., a MS-VAE) trained end-to-end with a decoder portion of the autoencoder such that the autoencoder can encode and decode at least workpiece data (e.g., and/or other inputs).

Any suitable autoencoder may be used in accordance with the present disclosure. One example autoencoder that may be used is a variational autoencoder. A variational autoencoder is an artificial neural network architecture including an encoder model (or encoder network) that maps inputs to a lower-dimensional latent space that corresponds to parameters of a variational distribution. The encoding can be sampled from the latent space. The variational autoencoder can additionally include a decoder model (or decoder network) that maps from the latent space to a recreation of the input data used to populate the latent space. The variational autoencoder may include a prior and a noise distribution.

Furthermore, in some implementations, the autoencoder may be a deep convolutional multiscale variational autoencoder (MS-VAE). The deep convolutional MS-VAE may be an autoencoder that is convolutional, e.g., that includes one or more convolutional neural networks. A convolutional neural network is a type of feed-forward neural network that applies multi-dimensional filters (or “kernels”) at inputs and/or links, weighing multiple prior nodes when advancing through layers. Additionally or alternatively, the MS-VAE can receive (and/or produce) inputs at multiple scales or resolution. For instance, the MS-VAE may receive some higher-resolution inputs (e.g, a higher-resolution residual image) and some lower-resolution inputs (e.g., a downsampled workpiece image) that are concurrently processed by the model. These inputs may be input to the model and/or generated by the model itself. For instance, the model may include one or more filters or downsampling operations to produce lower-resolution inputs from higher-resolution inputs. Alternatively, these inputs may be computed separately and provided to the model. As used herein, “providing” inputs to a machine-learned model is intended to cover these and other equivalent variations. It should be understood that the versatility of computing technology may provide for such variations to be within the scope of the present disclosure.

In some embodiments, the inspection model may be an SLGAN trained image translation model. The image translation model may transform the image data to generate a second image data output. For instance, the SLGAN trained image translation model may take a first image with a first associated set of information and provide as output a second image with a second associated set of information. The second associated set of information may include additional characteristics or information pertaining to the first image output relative to the first associated set of information. As an example, an image may be provided to the SLGAN trained image translation model which may produce a copy of the provided image, but with an enhanced set of metadata or information associated with the image. As an example, a first image (e.g., nondestructive image) of a workpiece may be capture in production during inspection of semiconductor workpieces (e.g., silicon carbide semiconductor wafers). The first image may be provided as input to the SLGAN trained image inspection model. The SLGAN trained image inspection model may provide as output a second image that may include data typically associated with other types of images, such as destructive images. Workpiece surface inspection and analysis may then be performed using the enhanced output image.

The image translation machine learned model may be trained using the SLGAN to provide improved feedback to the image translation model during training and ultimately improve overall output quality of the image translation model. In some embodiments, the discriminator portion of the SLGAN may provide feedback data to the image translation machine learned model based on the image translation model's output. Thus, the image translation model may update one or more parameters during training based on the feedback data from the discriminator portion of the SLGAN.

In another embodiment, the inspection model may be an SLGAN trained feature detection model. The feature detection model may perform a variety of classifications and data analysis based on the workpiece data associated with a semiconductor workpiece. For instance, the SLGAN trained feature detection model may perform object detection, workpiece classification, classification of the one or more features or feature distributions of the semiconductor workpiece, and/or segmentation of the semiconductor workpiece or one or more features or feature distributions associated with the semiconductor workpiece. As an example, the SLGAN trained feature detection model may generate a feature detection output that may identify the presence of one or more features on a semiconductor workpiece surface, classify each of the one or more features (e.g., super screw dislocation, stacking fault, scratch, etc.), determine spatial data of each of the one or more features (e.g., size, shape, coordinate location on wafer, etc.), and provide segmentation data of each of the one or more features. Additionally, in some instances, the feature detection output may include a target image including one or more pixels associated with the one or more features or feature distributions. In some instances, the feature detection model may be trained using the SLGAN, for instance using the discriminator portion of the SLGAN. The feature detection model may be trained, at least in part, by providing output to the discriminator portion of the SLGAN which may then provide feedback data to the feature detection model. The feature detection model may then update one or more parameters based on the feedback data from the discriminator portion of the SLGAN.

A variety of systems may be used to implement the inspection model discussed herein. For instance, one or more imaging devices may be configured to capture images of the semiconductor workpiece to provide as workpiece data to the inspection model. Additionally, processing circuitry (e.g., one or more processors and non-transitory, computer-readable media) may be used to store instructions that may obtain the workpiece data from the one or more imaging devices and provide the workpiece data to the machine-learned inspection model. The systems discussed herein may also obtain the output from the machine-learned inspection model. While one example system is provided, it should be appreciated that systems for performing the methods herein should not be limited to such. In practice, any computing system with one or more processors and non-transitory, computer readable media may perform the methods herein, for instance the processing of workpiece data with the machine-learned inspection model.

In some instances, the workpiece data provided as input to the inspection model may include image data of at least a portion of the semiconductor workpiece, such as one or more images. Additionally, the output from the inspection model may be an image output, such as second image data different than the image data provided as the input.

As used herein, an image is any two-dimensional representation of data associated with positional coordinates of a semiconductor workpiece. Data (nondestructive and destructive) that is spatially coordinated (e.g., to an x and y position of a workpiece) may be referred to as an image. In some examples, the images may be, for instance, optical surface microscopy images, photoluminescence (PL) microscopy images, cross-polarized light imaging images, and x-ray topography images, scanning electron microscopy images, or other images.

The images may be, for instance, nondestructive and/or destructive images of the workpiece. As used herein, the terms “nondestructive data” and “nondestructive image” of a workpiece respectively refer to data and an image that have been obtained without destroying, consuming, or otherwise damaging the workpiece. In this regard, nondestructive data and nondestructive images may be obtained for a workpiece on which one or more devices may subsequently be formed. For example, a spatially coordinated PL image of an unetched silicon carbide workpiece may be referred to as a nondestructive image. In contrast, the terms “destructive data” and “destructive image” refer to data or an image of a workpiece that has been destroyed, consumed, or otherwise damaged to the point that subsequent devices may not be formed thereon. For example, any spatially coordinated image of a silicon carbide workpiece that has been etched with KOH/EOH or the like to delineate etch pits may be referred to as a destructive image. Additionally, nondestructive and destructive data and corresponding images may include one or more data signals or data channels. For example, a data signal may comprise a light emission characteristic from a crystalline feature analyzed through a light filter. Data signals may correspond to absorption signals and/or emission signals.

The workpiece image can be captured by a suitable imaging device, such as PL microscope, x-ray topographic imaging source, cross-polarized light imaging source, optical camera, scanning electron microscope, etc. In some examples, the image may be a composite image of the semiconductor workpiece that has been stitched or aggregated together from multiple images (e.g., multiple different types of images).

As one example, the imaging device may provide workpiece images at a resolution of about 1 micron to about 10 microns per pixel, such as about 3 microns to about 10 microns, such as about 3 microns per pixel to about 7 microns per pixel, such as about 1.7 microns per pixel (e.g., for optical microscopy images) or 3 microns per pixel (e.g., for PL images) or about 7 microns per pixel (for x-ray topography images).

In some examples, for instance, when using scanning electron microscopy-based images, the resolution may be less than 1 micron per pixel, such as in a range of about 0.5 nanometers and about 10 nanometers per pixel or in a range of about 1 nanometer to about 20 nanometers per pixel. Certain examples of the present disclosure may be discussed with micron scale resolution for purposes of illustration and discussion. Those of ordinary skill in the art, using the disclosures provided herein, will understand that the systems and methods may be used with images having nanometer scale resolution, such as scanning electron microscopy images, without deviating from the scope of the present disclosure.

The workpiece image can span an entire surface of the semiconductor workpiece. In some examples, the workpiece image can span a portion of the semiconductor workpiece. In some examples, multiple smaller images depicting portions of the semiconductor workpiece can be stitched or joined together to form the workpiece image.

One example aspect of the present disclosure is directed to a method for training a GAN using a stabilized learning rate to generate an SLGAN trained model according to examples of the present disclosure. An SLGAN may include two distinct neural networks, a generative network and a discriminator network. The two neural networks may be trained simultaneously using the output data from one network to train the other and vice versa. For instance, the generated output of the generator network may be used as input to assist in training the discriminator network and the output of the discriminator network may be used to train the generator network. As the two neural networks learn from each other, they develop a ‘learning rate’, a rate at which their output improves in similarity toward their respective intended target. While the neural networks may train simultaneously, the learning rates associated with each neural network may not progress simultaneously. Inconsistent learning rates between neural networks within a GAN, or conditional GAN (CGAN), may result in one neural network significantly improving relative to the other and ultimately defeating the opposing neural network and stalling its growth. Since both neural networks rely on the output of the other to improve, the stalling of one network will ultimately stall the other, thus defeating the GAN entirely. Accordingly, aspects of the present disclosure provide a stabilized learning rate which may detect an imbalance in the respective learning rates of the neural networks within the GAN and adjust the training parameters of one or more of the neural networks to re-stabilize the out of balance learning rate associated with one or more of the neural networks.

In some embodiments, a GAN may be trained using a stabilized learning rate to generate an SLGAN by conducting a first training epoch for a generative network within the GAN and obtaining a first loss associated with the generative network, and comparing the first loss to a second loss associated with a discriminator network within the GAN determined from a second training epoch for the discriminator network. Based on the comparison between the first loss and the second loss, a learning rate for either the generative network and/or the discriminator network may be accelerated, stalled, or otherwise regulated to mitigate the imbalance between the first loss and the second loss.

In some embodiments, regulating the learning rates of the generative network and the discriminator network may include determining an adversarial ratio—a metric based at least in part on the first loss associated with the generative network and the second loss associated with the discriminator network. In some examples, the adversarial ratio may be determined based, at least in part, on a ratio of the first loss to the second loss. Additionally, in some embodiments, regulating the learning rates of the two networks may include comparing the adversarial ratio to a threshold value, such as about 1.0. In embodiments including a threshold comparison, the learning rate of the generative network and/or the discriminator network may be regulated based on the adversarial ratio exceeding or falling below the threshold.

Various methods may be employed to regulate the learning rate of one or more of the generative network and the discriminator network. For instance, in some embodiments, the learning rate of either neural network may be regulated by holding one or more parameters of either neural network fixed for future training epochs relative to the other neural network. Additionally, in some embodiments, the learning rate of either neural network may be regulated by updating parameters of either neural network relative, or independent, to the other. Regulation of either learning rate may also be based on an algorithmic function. For instance, the learning rate of the generative network or discriminator network may be regulated based on a function mapping of the adversarial ratio. In some examples, the learning rate of either neural network may be regulated based on a stochastic mapping of the adversarial ratio.

The SLGAN generated through the training methods disclosed herein may be implemented in a variety of applications. For instance, in some embodiments, the SLGAN may be implemented to assist in training a machine-learned model for processing an image of a semiconductor workpiece. More specifically, the SLGAN may be implemented to train machine learned models for feature detection, image translation, autoencoding, and/or similar data processing techniques.

Example aspects of the present disclosure can provide a number of technical effects and benefits, including improvements to computing technology and/or semiconductor fabrication technology. For instance, the use of SLGAN trained machine learned models within the semiconductor manufacturing process may substantially decrease the length of wafer inspection processes and satisfy the rapid manufacturing capacity expansion needed to meet the demand for several industries consuming semiconductor devices, such as the automotive industry, artificial intelligence industries, electronics industries, and similar electronics industries. The systems and methods according to the present disclosure can solve several inspection steps through the workpiece and semiconductor processes such as, for example, detection of anomalies or defects like scratches, stacking faults, super screw dislocations, and similar wafer manufacturing defects. Although there are many scalability challenges for manual inspection processes such as training, quality control, floor space and proper feedback metrics for process development, these challenges have endured as conventional systems have lacked comparable ability to detect strange and anomalous features. Example aspects of the present disclosure, however, can provide similarity comparisons and anomaly detection with comparable performance to manual inspection.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that when an element such as a layer, structure, region, or substrate is referred to as being “on” or extending “onto” another element, it may be directly on or extend directly onto the other element or intervening elements may also be present and may be only partially on the other element. In contrast, when an element is referred to as being “directly on” or extending “directly onto” another element, there are no intervening elements present, and may be partially directly on the other element. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

As used herein, a first structure “at least partially overlaps” or is “overlapping” a second structure if an axis that is perpendicular to a major surface of the first structure passes through both the first structure and the second structure. A “peripheral portion” of a structure includes regions of a structure that are closer to a perimeter of a surface of the structure relative to a geometric center of the surface of the structure. A “center portion” of the structure includes regions of the structure that are closer to a geometric center of the surface of the structure relative to a perimeter of the surface. “Generally perpendicular” means within 15 degrees of perpendicular. “Generally parallel” means within 15 degrees of parallel.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the disclosure are described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Similarly, it will be understood that variations in the dimensions are to be expected based on standard deviations in manufacturing procedures. As used herein, “approximately” or “about” includes values within 10% of the nominal value.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Some embodiments of the invention are described with reference to semiconductor layers and/or regions which are characterized as having a conductivity type such as n type or p type, which refers to the majority carrier concentration in the layer and/or region. Thus, n type material has a majority equilibrium concentration of negatively charged electrons, while p type material has a majority equilibrium concentration of positively charged holes. Some material may be designated with a “+” or “−” (as in n+, n−, p+, p−, n++, n−−, p++, p−−, or the like), to indicate a relatively larger (“+”) or smaller (“−”) concentration of majority carriers compared to another layer or region. However, such notation does not imply the existence of a particular concentration of majority or minority carriers in a layer or region.

As used herein, an “epoch” refers to a duration of training iterations for training a machine-learned model. More specifically, an epoch refers to a single complete iteration through a training dataset for a machine learned model. The dataset may be any size or include any number of training instances (e.g., images). Training a machine-learned model may involve a plurality of epochs to train the model, such as between about 2 epochs to about 12 epochs, dozens of epochs, hundreds of epochs, thousands of epochs, etc. Certain examples of the present disclosure may use any number of epochs without deviating from the scope of the present disclosure. Each epoch may be associated with a training dataset that includes any number of training instances (e.g., images) or varying numbers of training instances without deviating from the scope of the present disclosure.

One or more parameters for training a machine learned model may be associated with handling the number of epochs between significant training events. For example, one parameter may be dedicated to a division of the number of epochs to perform a loss determination of the model (e.g., determine loss every 20 epochs). As another example, in a GAN, one parameter may be dedicated to a division of the number of epochs to compare the discriminator output to the generator output (e.g., compare outputs every 5 epochs).

In the drawings and specification, there have been disclosed typical embodiments and, although specific terms are employed, they are used in a generic and descriptive sense only and not for purposes of limitation of the scope set forth in the following claims.

Aspects of the present disclosure are discussed with reference to input data that includes images of semiconductor workpieces. Those of ordinary skill in the art, using the disclosures provided herein, will understand that aspects of the present disclosure may be applicable to other types of data, such as other types of images, without deviating from the scope of the present disclosure.

With reference now to the Figures, example embodiments of the present disclosure will be discussed in further detail.

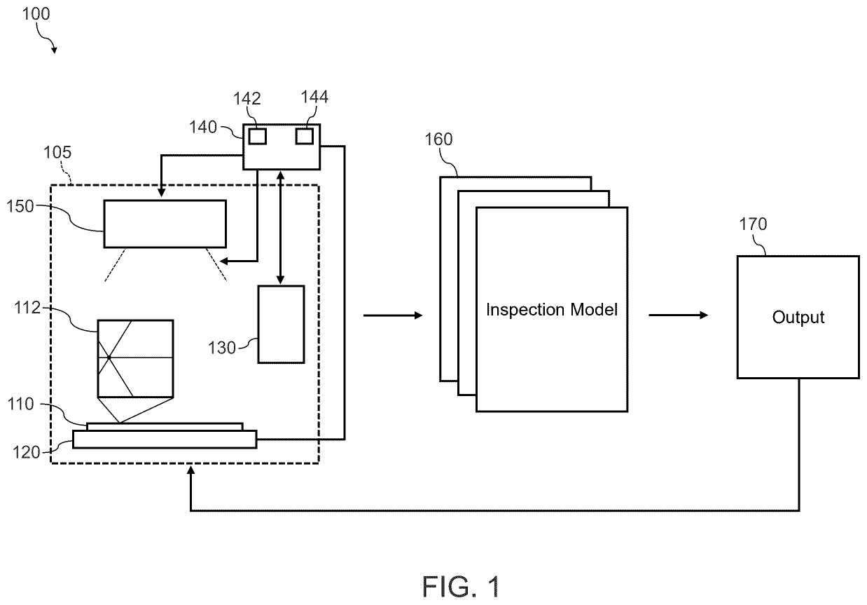

FIG. 1 depicts an example process 100 for inspecting a semiconductor workpiece according to example aspects of the present disclosure. The example process 100 includes a semiconductor inspection system 105 configured to inspect a semiconductor workpiece 110, such as a silicon carbide semiconductor wafer. Those of ordinary skill in the art, using the disclosures provided herein, will understand that the system 105 may include more or fewer components without deviating from the scope of the present disclosure. The system 105 may be configured to implement one or more aspects of the present disclosure, such as the processing operations for inspecting and/or classifying of semiconductor workpieces described herein.

The system 105 can include a workpiece support 120 configured to support the semiconductor workpiece 110. The workpiece support may include a chuck (e.g., a vacuum chuck) or other workpiece holder to secure the semiconductor workpiece 110 during processing by the system 105. In some implementations, the workpiece support 120 may provide a surface on which the semiconductor workpiece 110 rests. In some implementations, the workpiece support 120 may provide for moving, rotating, angling, or otherwise reorienting the workpiece 110 relative to the system 105. In some examples, the system 105 may include a workpiece handling robot operable to move the workpiece to the workpiece support 120.

The system 105 can include one or more imaging devices 150. The imaging device(s) 150 can obtain one or more workpiece images 112 from the surface of the workpiece 110, such as workpiece image 112 (e.g., workpiece data). The workpiece image 112 may have a resolution, which may be dependent in part on a resolution of the imaging device(s) 150. As one example, the resolution may have approximately 1 microns per pixel to about 10 microns per pixel. However, ins some examples, the resolution may be less than 1 micron per pixel. The imaging device(s) 150 may include one or more imaging devices, such as one or more of a PL microscope, x-ray topographic imaging source, cross-polarized light imaging source, camera, infrared camera, camera associated with non-visible light wavelengths, scanning electron microscope, or other suitable device configured to obtain data associated with spatial coordinates of the workpiece. The imaging devices 150 may develop images in a variety of formats. As examples, the imaging devices 150 may capture the one or more workpiece images 112 as optical surface microscopy images, photoluminescence (PL) microscopy images, cross-polarized light imaging images, x-ray topography images, or scanning electron microscopy images.

In some embodiments, the system 105 may additionally include one or more sensors 130 for obtaining data associated with the semiconductor workpiece 110, such as workpiece classification data for the semiconductor workpiece 110. Workpiece characterization data is data that provides information associated with the semiconductor workpiece 110, such as topography, roughness, presence of anomalies, doping, thickness, and/or other characteristics. Workpiece characterization data may include, for instance, an image of the surface of the workpiece 110 and/or a topological map of the surface of the workpiece 110. In some embodiments, the one or more sensors 130 may include one or more surface measurement lasers that may be operable to emit a laser onto the surface of the workpiece 110 and scan the surface (based on reflections of the laser) for depth measurements, topography measurements, etc. of the surface of the workpiece 110. Other suitable sensors may be used without deviating from the scope of the present disclosure.

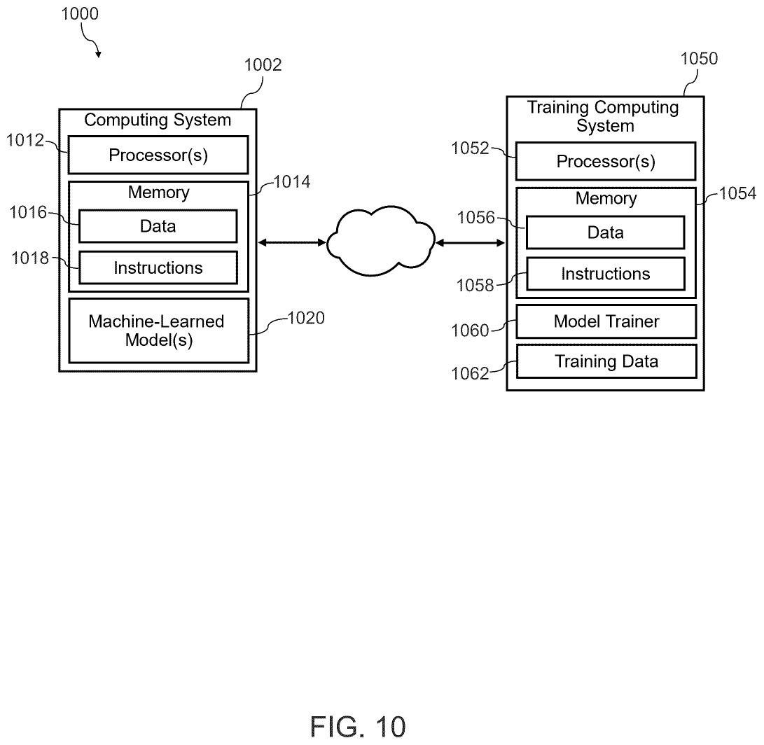

The system 105 includes one or more control devices, such as a controller 140. The controller 140 may include processing circuitry such as one or more processors 142. The controller may include one or more memory devices 144. The one or more memory devices 144 may store computer-readable instructions that when executed by the one or more processors 142 cause the one or more processors 142 to perform one or more control functions, such as any of the functions described herein. In some examples, the one or more memory devices 144 may store the inspection model 160 containing one or more SLGAN trained machine learned models. The one or more processors 142 may perform operations to provide workpiece data, such as the workpiece images 112, to the inspection model 160 within the one or more memory devices 144 and determine their output. Additionally, the controller 140 may be in communication with various other aspects of the system 105 through one or more wired and/or wireless control links. The controller 140 may send control signals to the various components of the system 105 (e.g., the workpiece support 120, the imaging device(s) 150, the sensor(s) 130, etc.) to implement the aspects of the present disclosure described herein. Additionally, the controller 140 may include one or more machine-learned models (e.g., a machine-learned encoding model, autoencoder, image translation model, feature detection model, etc.) for inspecting and/or classifying of semiconductor workpieces, as described herein. As one example, the controller 140 may be, may include, or may be in communication with at least a portion of the computing system 1000 of FIG. 10 (e.g., the computing system 1002 and/or the training computing system 1050).

In some embodiments, the semiconductor system 105 may obtain workpiece data relating to the semiconductor workpiece 110 for processing by the inspection model 160. As an example, the system 105 may provide the one or more workpiece images 112 to the inspection model 160 as workpiece data. The inspection model 160 may include a variety of machine learned models, specifically SLGAN trained machine learned models, each with varying capabilities to process the workpiece data from the system 105. For example, the inspection model 160 may contain one or more of an SLGAN trained autoencoder, image translation, or feature detection machine learned model to process the one or more workpiece images 112.

The inspection model 160 may process received workpiece data and produce an output 170 that may include a variety of data associated with one or more characteristics of the semiconductor workpiece 110 in a variety of forms. As examples, the output 170 may be an encoding of the workpiece data, a feature detection output, or an image translation output. Each type of output 170 may provide information relating to a plurality of characteristics pertaining to the semiconductor workpiece 110 and one or more features associated with the semiconductor workpiece 110. In some embodiments, the output 170 may be used to modify one or more semiconductor manufacturing processes, based on the characteristics of one or more features present within the output 170.

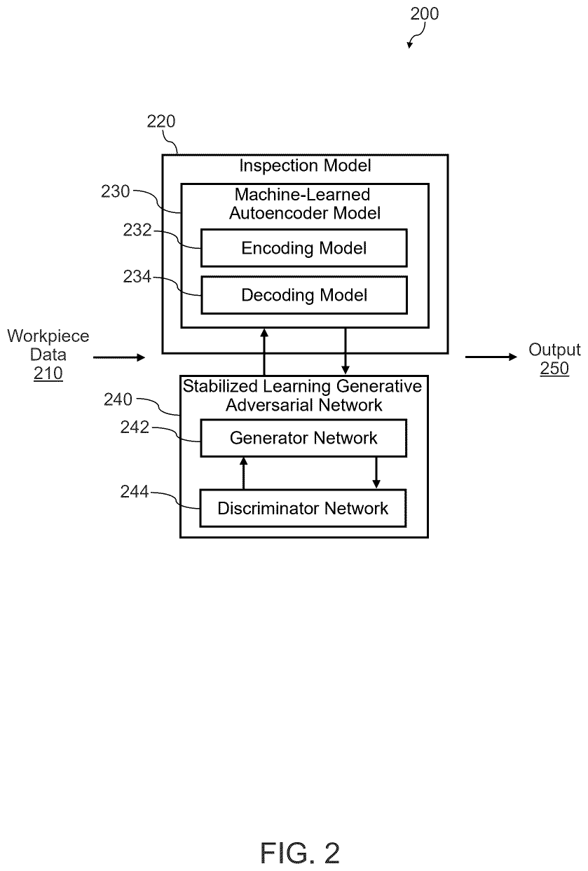

FIG. 2 depicts an example process 200 for inspecting semiconductor workpieces according to examples aspects of the present disclosure. The example process 200 includes processing workpiece data 210 with an inspection model 220 to produce an output 250 associated with one or more characteristics of a semiconductor workpiece associated with the workpiece data 210. The workpiece data 210 may be a variety of data types and data formats. For instance, the workpiece data 210 may be image data of at least a portion of the semiconductor workpiece, such as one or more images, tabular data, or time series data. In one example, as depicted in FIG. 1, the workpiece data 210 may be image data of at least a portion of a semiconductor workpiece. The image data may be taken using a variety of imaging devices and techniques to create different image types and formats. As examples, when image data makes up the workpiece data, the image data may be one or more of an optical surface microscopy image, photoluminescence (PL) microscopy image, cross-polarized light imaging image, x-ray topography image, or a scanning electron microscopy image. Once generated, the workpiece data, regardless of form, may be provided to the inspection model 220 as input.

As depicted, in some implementations, the inspection model 220 may be a machine-learned autoencoder model 230. The autoencoder model 230 may include both an encoding portion 232 (e.g., encoding model(s)) and a decoding portion 234 (e.g., decoding model(s)). Any input to the inspection model 220, such as workpiece data 210, may be provided to the encoding portion of the autoencoder model to generate an encoding of the input. The encoding portion 232 can be any suitable encoding or encoder model. An encoding model can receive various types of input (e.g., image data, alphanumerical data, etc.) and, in response to receipt of the input data, produce an encoding as output. The encoding can be a representation of the input variables in a machine-encoded format (e.g., a numerical format). In some examples, the encoding may not be human-readable. However, characteristics and trends among the input data may be represented in characteristics of the encoding. In particular, the encoding model can be trained to produce encodings that represent characteristics of the input data by training the encoding model end-to-end with a decoding or decoder model. For instance, in some examples, the encoding of the input workpiece data 210 may be indicative of one or more features, feature distributions, anomalies, or similarities of a semiconductor workpiece.

The decoding portion 234 can be configured to receive an encoding as input and, in response to receipt of the encoding as input, produce output in a human-intelligible or other suitable format, such as image data, alphanumerical data, classification data, or other suitable data. In some implementations, the encoding portion 232 and decoding portion 234 may not necessarily be related or be part of a common model schema. For instance, the encoding portion 232 and the decoding portion 234 may be independent models having separate networks (e.g., neural networks). In some examples, the encoding portion 232 may be any suitable machine learned model that is trained to produce an encoding that represents input data. The model can have any number of parameters without deviating from the scope of the present disclosure. The model can have various model architectures (e.g., any number convolutional layers, transformer layers, etc.) without deviating from the scope of the present disclosure.

In some implementations, the autoencoder model 230 may be trained, at least in part, using an SLGAN 240 including a generator network 242 and a discriminator network 244. For instance, the decoding portion 234 of the autoencoder model 230 (e.g., decoding model) may be trained using the discriminator network 244 of the SLGAN. In some examples, the decoding portion 234 is the generator network 242 of the SLGAN 240. In some examples, the decoding portion 234 may be configured to generate a target image based on a provided encoding input (e.g., the encoding from the encoding portion 232 of the autoencoder 230). The discriminator network 244 within the SLGAN 240 may be used to train the decoding portion 234 of the autoencoder 230 to generate better target images by taking the output of the decoding portion 234 as input and providing feedback data to the decoding portion 234. As a result, the encoding portion 232 of the autoencoder model 230 may receive improved feedback and training from the decoding portion 234 based on the improved feedback and training of the decoding portion 234 from the SLGAN 240. Further, in some embodiments, the output 250 of the inspection model 220 may be an encoding from the SLGAN 240 trained autoencoder model 230. In these embodiments, the encoding may be indicative of one or more characteristics of a semiconductor workpiece from which workpiece data 210 is received, such as a similarity or anomaly of the semiconductor workpiece. Additionally, in some embodiments, the encoding provided as output 250 from the autoencoder model 230 may be indicative of a feature or feature distribution of the semiconductor workpiece associated with the workpiece data 210.

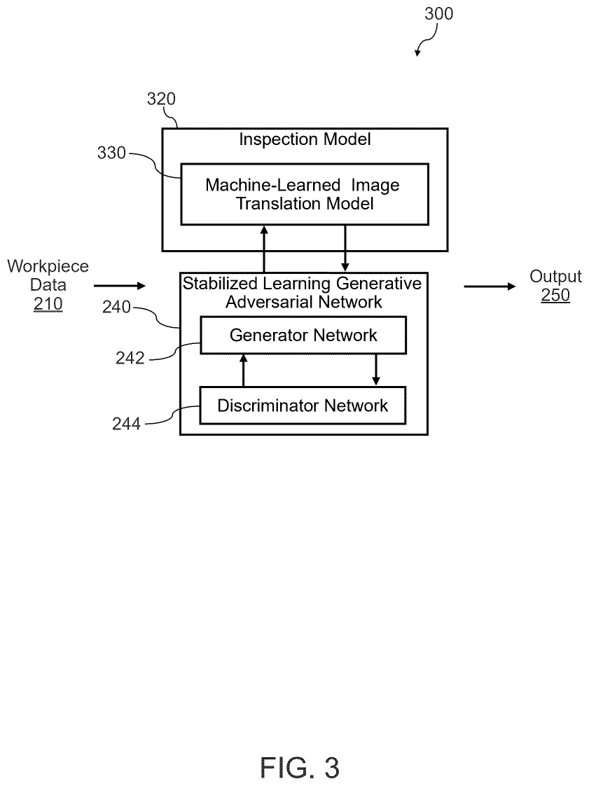

FIG. 3 depicts an example process 300 for inspecting semiconductor workpieces according to examples aspect of the present disclosure. The process 300 includes receiving workpiece data 210 and providing the workpiece data 210 to an inspection model 320 to produce an output 250. In some embodiments, the inspection model 320 may be a machine-learned image translation model 330 trained using the SLGAN 240. The image translation model 330 may receive any input to the inspection model 320 and perform one or more image processing procedures or transformations to generate the output 250. As an example, the image translation model 330 may receive as input a first image with a first set of associated information (e.g., metadata, embedded feature data, caption, etc.) and output a second image different from the first image with a second set of associated information that is enhanced compared to the first set of associated information. For instance, the first set of associated information may be associated with a first type of image (e.g., PL image), whereas the second set of associated information may be associated with a second type of image (e.g., birefringent cross-polarization image). In some examples, the first set of information may be associated with non-destructive data and the second set of information may be associated with destructive data. In some embodiments, based on the output 250, one or more characteristics of the semiconductor workpiece associated with the workpiece data 210 may be determined.

In some embodiments, the image translation model may be trained using the SLGAN 240. The SLGAN may include a generator network 242 and a discriminator network 244. In some examples, the image translation model 330 may be the generator network 242. In some implementations, the discriminator network 244 of the SLGAN 240 may provide feedback data to the image translation model 330 during training to improve the output of the image translation model 330.

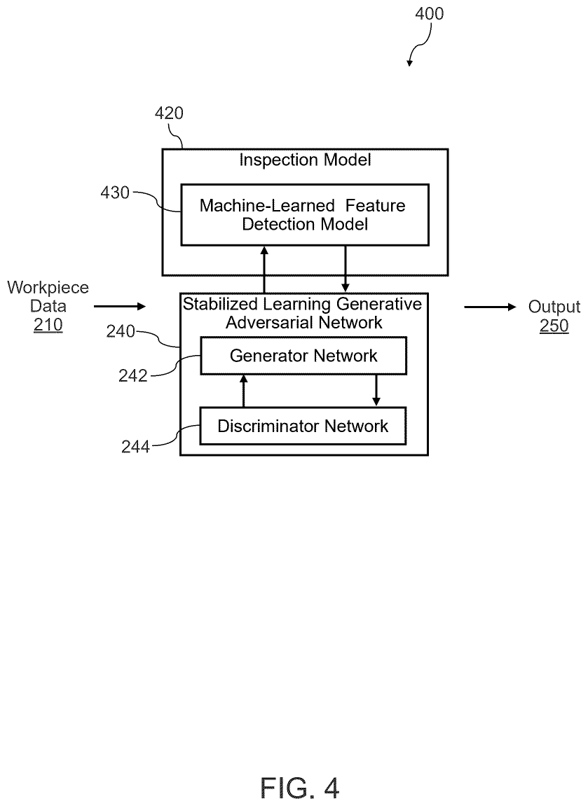

FIG. 4 depicts an example process 400 for inspecting semiconductor workpieces according to examples aspects of the present disclosure. The example process 400 includes processing the workpiece data 210 with an inspection model 420 to produce an output 250 associated with one or more characteristics of a semiconductor workpiece associated with the workpiece data 210. In some implementations the inspection model 420 includes a machine-learned feature detection model 430 trained using the SLGAN 240. The feature detection model 430 may take any input to the inspection model 420, such as workpiece data 210, and generate a feature detection output as output 250.

The feature detection output may include a variety of data and formats. For instance, in some implementations, the feature detection output may be a target image including one or more pixels associated with a feature or feature distribution of a semiconductor workpiece associated with the workpiece data 210. For instance, pixels where a feature is detected may have a first value and pixels where a feature is not detected may have a second value that is different from the first value. Example features may include, but are not limited to, a threading edge dislocation, basal plan dislocation, super screw dislocation, micropipe, mixed dislocation, hexagonal void, stacking fault, or scratch. Additionally, in some implementations, the feature detection output may include data indicative of one or more locations of a feature or feature distribution, classification of a feature or feature distribution, size of a feature or feature distribution, or shape of a feature or feature distribution. As an example, the feature detection model 430 may receive image data of at least a portion of a semiconductor workpiece, such as one or more images, as input and output the image data with an identification of one or more features present within the image data, a classification of the features present (e.g., threading edge dislocation, basal plan dislocation, super screw dislocation, etc.), and an image segmentation of each of the features present. In some embodiments, based on the output 250, one or more characteristics of the semiconductor workpiece associated with the workpiece data 210 may be determined.

As illustrated in FIG. 4, the feature detection model 430 may be trained using the SLGAN 240. The SLGAN may include a generator network 242 and a discriminator network 244. In some examples, the feature detection model 430 may be the generator network 242. In some implementations, the discriminator network 244 of the SLGAN 240 may provide feedback data to the feature detection model 430 during training to improve the output of the feature detection model 430.

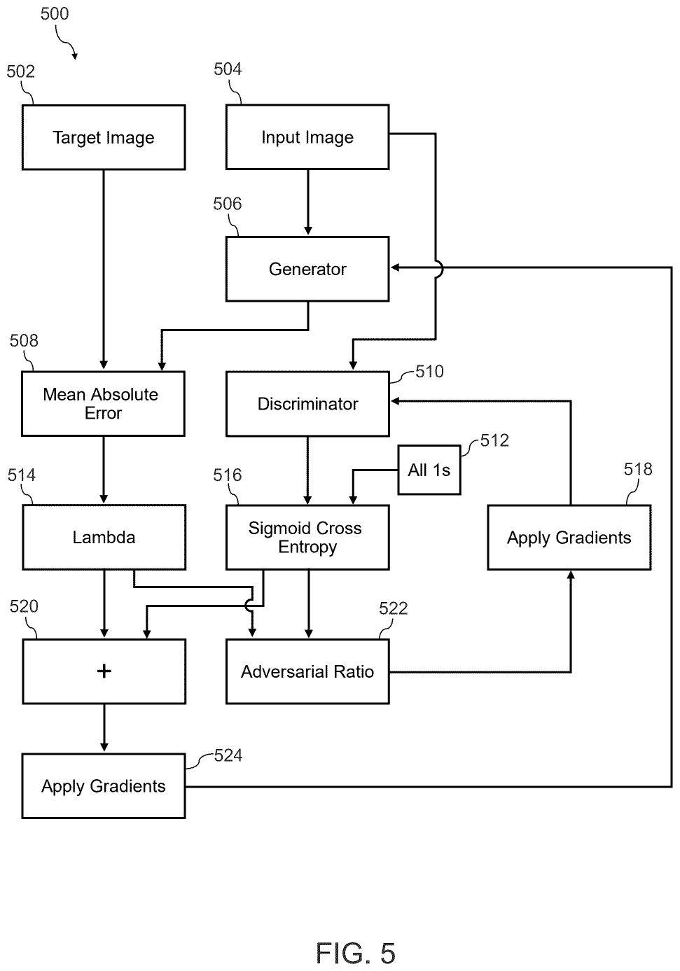

FIG. 5 depicts a flow diagram of an example method 500 for training an SLGAN according to example aspects of the present disclosure. The SLGAN includes a generator network 506 and a discriminator network 510, with the generator network 506 being trained to generate images as close to a target image 502 as possible and the discriminator network 510 being trained to determine whether the input image 504 is a real image or a generated image from the generator network 506. As such, the input image 504 may be any image or images including, but not limited to, images generated by the generator network 506.

Referring to the training cycle for the generator network 506 of the SLGAN, the generator network 506 receives an input image 504, performs one or more operations with the input image 504, and generates an output image, different from the input image 504. The output image is compared to a target image 502 (e.g., an image intended for the generator 506 to generate) and a mean absolute error between the target image 502 and the generator network 506 output is determined. To be evaluated along with the sigmoid cross entropy 516, the mean absolute error 508 may be scaled by a lambda factor 514. The lambda factor 514 may be any value determined to scale the mean absolute error to be comparable with the sigmoid cross entropy 516 (e.g., scale by a factor of 100 as the sigmoid cross entropy is a scale of 100× bigger yet relates the same information). The lambda-scaled mean absolute error 508 may be combined with the sigmoid cross entropy 516 from the discriminator network 510 training and, based on the mean absolute error 508 and sigmoid cross entropy 516, at 524, one or more gradients may be applied to the generator network 506.

Referring to the training cycle for the discriminator network 510 of the SLGAN, the discriminator receives an input image 504, performs one or more operations with the input image 504, and generates a probability mapping pertaining to the authenticity of the input image 504 (e.g., whether the input image was a labeled ‘real’ image or an image generated by the generator network 506). The discriminator network 510 output may be compared to an array of all 1's 512 to determine the sigmoid cross entropy 516 of the discriminator 510 output. The discriminator 510 output may be compared to all 1's 512 because the discriminator output is a plurality of probabilities as to whether the input image 504 is real, with ones signifying a real image. The sigmoid cross entropy 516 may be used to determine the adversarial ratio 522 along with the lambda-scaled mean absolute error 508.

In some implementations, the adversarial ratio 522 may be determined, at least in part, by a ratio of the loss associated with the generator 506 and the loss associated with the discriminator 510. In some embodiments, based on the determined adversarial ratio 522, at 518, one or more gradients may be applied to the discriminator 510 neural network. Conversely, in some embodiments, one or more gradients may not be applied to the discriminator 510 neural network based on the adversarial loss ratio. Further, while not depicted, in some implementations the adversarial loss ratio may be utilized at 524 to determine whether to apply one or more gradients to the generator 506 neural network.

Determining whether to apply one or more gradients to the discriminator network 510 or generator network 506 may be performed in a variety of methods. As an example, the adversarial ratio 522 may be compared to one or more threshold values (e.g., thresholds), such as a threshold of 1.0. If the adversarial ratio exceeds or falls below the threshold, one or more parameters for the discriminator network 510 or the generator network 506 may or may not be updated. For example, in some embodiments, if the adversarial ratio 522 exceeds the threshold, the parameters for the discriminator network 510 are held constant until the adversarial ratio 522 falls back below the threshold. In some embodiments, if the adversarial ratio 522 is below the threshold, one or more parameters of the discriminator network 510 and/or generator network 506 may be updated. Other example implementations of determining whether to apply gradients based on the adversarial ratio 522 include using a function mapping of the adversarial ratio and/or a stochastic mapping of the adversarial ratio, however this list is not exhaustive. In practice, any application of the adversarial ratio to regulate the learning rate of one or more neural networks within a GAN is embodied within the present disclosure.

In some examples, the training cycle(s) depicted in FIG. 5 may be implemented through a plurality of iterations and epochs to train the generator network 506 and discriminator network 510. For instance, in some implementations, the generator network 506 and discriminator network 510 may each undergo a training epoch, the generator network 506 undergoing a first training epoch and the discriminator network 510 undergoing a second training epoch, and a loss for each network may be determined from each training epoch. For example, a first loss (e.g., lambda-scaled mean absolute error 508) may be determined for the generator network 506 based on the first training epoch and a second loss (e.g., sigmoid cross entropy) 516 may be determined for the discriminator network 510 based on the second training epoch. Based on the first loss and the second loss (e.g., the adversarial ratio 522), the effective learning rate for either the generator network 506 or discriminator network 510, or both, may be regulated. For example, the discriminator network 510 effective learning rate may be regulated by choosing whether to apply gradients for a next training epoch. Likewise, in some examples, the generator network 506 learning rate may be regulated by choosing whether to apply one or more gradients, or update one or more parameters, for the next training epoch. Regulating the learning rates of both the generator network 506 and discriminator network 510 over a period of epochs may result in an effective trained GAN with a stabilized learning rate, an SLGAN. Once trained, examples implementations of the SLGAN include processing images of semiconductor workpieces, such as silicon carbide wafers, using autoencoder models, image translation models, and feature detection models discussed throughout the present disclosure.

As used herein, “learning rate” and “effective learning rate” refer to the rate at which a machine-learned model approaches successful completion of its target task. For instance, the learning rate for a discriminator network, such as discriminator network 510, is the rate at which the discriminator successfully learns to distinguish input images as generated or real images. Likewise, the learning rate for a generator network, such as generator network 506, is the rate at which the generator successfully learns to convince the discriminator its output is a real, not generated, image.

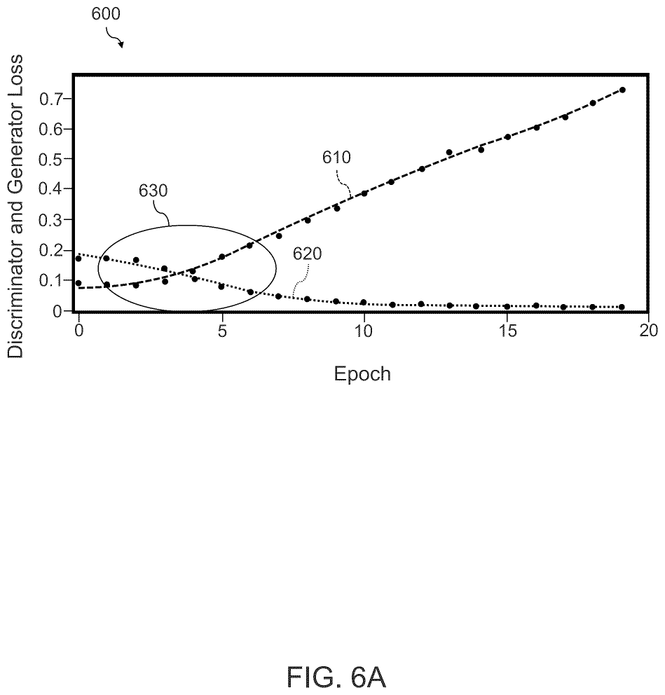

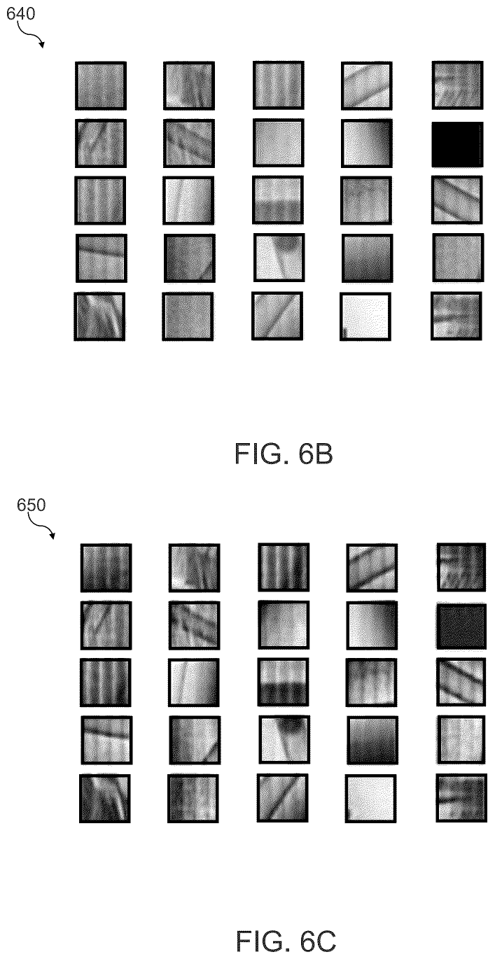

FIG. 6A depicts a XY plot 600 of traditional GAN losses, both discriminator network loss and generator network loss, over a plurality of epochs. The horizontal axis depicts the number of epochs while the vertical axis depicts loss. The discriminator network learning rate is represented by curve 610. The generator network learning rate is represented by curve 620. At 630, the plot 600 depicts a destabilizing event wherein the learning rates of the discriminator network and generator network de-couple and begin drastically different loss trajectories. What can happen, and is depicted here, is the generator network overcomes the discriminator network early in the training process and the feedback data each network receives from the other becomes ineffective. The generator network learning rate represented by curve 620 rapidly progresses toward 0 because the discriminator is unable to effectively recognize the difference between control input and generator input due to how early on the discriminator network failed to identify the generator input. The discriminator network learning rate represented by curve 610 begins rapidly increasing away from 0 because the discriminator was overcome by the generator early enough that it believes the generator provided input is really the control input, as opposed to the actual control input. When the destabilizing event 630 occurs in a training session, the overall GAN model effectiveness is significantly impacted. The generator network learning rate represented by curve 620, while close to zero, does not produce usable output data because the loss is an indicator of success in overcoming the discriminator network, not producing usable output. Likewise, the discriminator network learning rate represented by curve 610 is incredibly high and therefore unusable as the discriminator network is ineffective at classifying input data properly. Aspects of the present disclosure relate to implementing a stabilized learning rate to prevent destabilizing events, such as destabilizing event 630, from occurring during GAN training and produce more effective generator networks and discriminator networks within GANs for semiconductor manufacturing inspection.

FIG. 6B depicts a set of validation images 640 used for evaluating a discriminator network of a GAN according to certain methods of GAN training. In particular, FIG. 6B depicts real images of portions of example semiconductor workpieces for the purposes of illustration and discussion. As an example, the validation images 640 may be images indicative of one or more features of a semiconductor workpiece. The validation images 640 may be provided as input to a currently training, or trained, discriminator network of a GAN to generate an evaluation output. For each image of the set of validation images 640, the discriminator network may generate an evaluation output indicative of whether the discriminator network believes the image is real or generated (e.g., a generated image from the generator network of the GAN).

FIG. 6C depicts a set of generated images 650 used for evaluating a discriminator network of a GAN according to traditional methods of GAN training. In particular, FIG. 6C depicts generated images from the generator network of a currently training, or trained, GAN. The primary objective of the generator network in the GAN is to generate images as similar to the set of validation images 640 depicted in FIG. 6B as possible. The set of generated images 650 may be used to, at least partially, train the discriminator network of a GAN along with the set of validation images 640 depicted in FIG. 6B. The set of generated images 650 may be provided to the discriminator network as input and an evaluation output may be generated. The evaluation output may be indicative of whether the discriminator network believes the input is either a real image, such as an image from the set of validation images 640, or a generated image, such as an image from the set of generated images 650. The evaluation output may be provided to the generator network as feedback data to train the generator network.

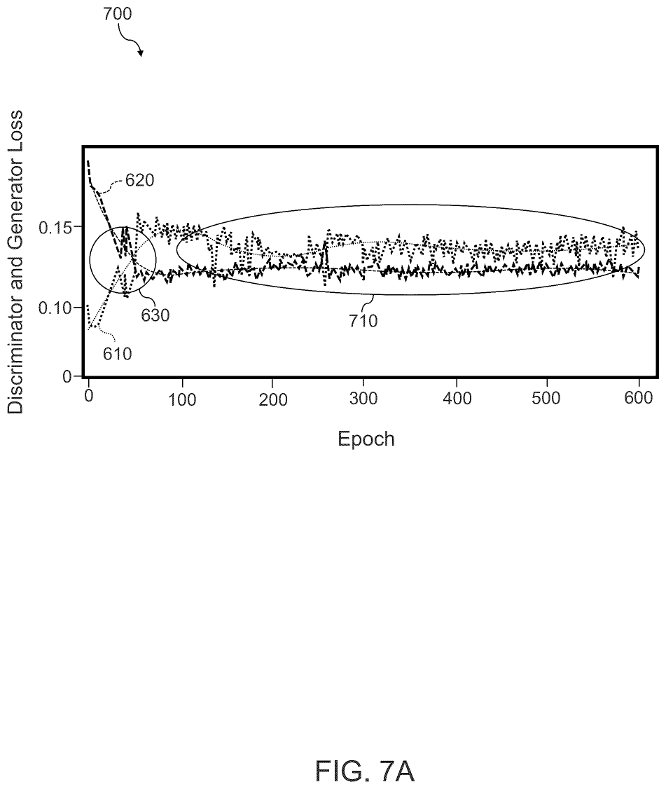

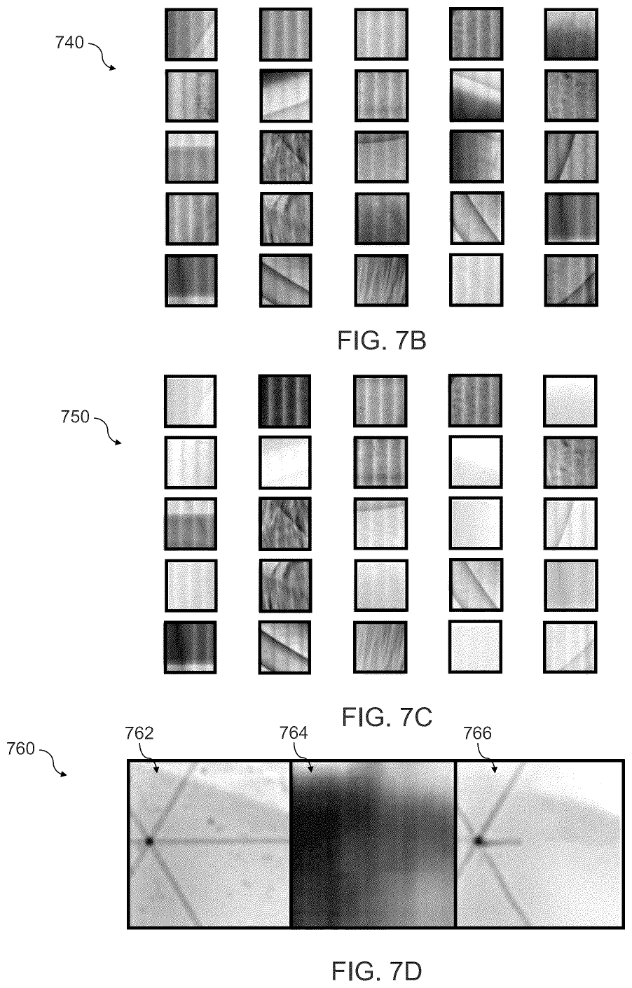

FIG. 7A depicts a XY plot 700 of SLGAN network loss over a plurality of epochs according to examples aspects of the present disclosure. The horizontal axis depicts a number of epochs while the vertical axis depicts loss. The discriminator network learning rate is represented by curve 610. The generator network learning rate is represented by curve 620. The plot 700 additionally depicts a destabilizing event 630 wherein the learning rates of the discriminator network and generator network de-couple and begin substantially different loss trajectories. However, as opposed to the plot 600 depicted in FIG. 6A, the discriminator network learning rate represented by curve 610 and the generator network learning rate represented by curve 620 re-align trajectories through further epochs and begin on parallel loss trajectories 710 with substantially similar losses for a significantly larger number of epochs compared to the losses depicted FIG. 6A. Accordingly, FIG. 7. depicts the active involvement of one or more example stabilized learning methods of the present disclosure. In some embodiments, the stabilized learning method may include an adversarial ratio, a ratio determined at least in part by a ratio of a loss of the generator network of a GAN to a loss of the discriminator network of the GAN. Implementations including an adversarial ratio may also include a threshold value (e.g., threshold), such as a threshold value of 1.0. In some embodiments, if the adversarial ratio ever decouples from the adversarial ratio, such as if the adversarial ratio becomes greater than the threshold, such as destabilizing event 530, one or more parameters or gradients of the discriminator network or generator network may be frozen or modified until the adversarial ratio recouples with the threshold (e.g., adversarial ratio is less than or equal to threshold or vice versa), such as until parallel loss trajectories 710 are present.

FIG. 7B depicts a set of images 740 used for training a GAN according to example aspects of the present disclosure. In particular, FIG. 7B depicts real images of portions of semiconductor workpieces for the purposes of illustration. As an example, the images 740 may be images indicative of one or more features of a semiconductor workpiece. In some implementations, the images 740 may be provided as input to a currently training, or trained, discriminator network of a GAN to generate an evaluation output. For each image of the set of images 740, the discriminator network may generate an evaluation output indicative of whether the discriminator network believes the image is real or generated (e.g., a non-generated image or a generated image from the generator network of the GAN). Additionally, in some embodiments, the set of images 740 may be provided as input to the generator network as target images for image generation (e.g., image reconstruction).

FIG. 7C depicts a set of generated images 750 used for evaluating a discriminator network of a GAN according to example aspects of the present disclosure. In particular, FIG. 7C depicts generated images from the generator network of a currently training, or trained, GAN. The primary objective of the generator network in the GAN is to generate images as similar to the set of images 740 depicted in FIG. 7B as possible. The set of generated images 750 may be used to, at least partially, train the discriminator network of a GAN along with the set of validation images 740 depicted in FIG. 7B. The set of generated images 750 may be provided to the discriminator network as input and an evaluation output may be generated. The evaluation output may be indicative of whether the discriminator network believes the input is either a real image, such as an image from the set of validation images 740, or a generated image, such as an image from the set of generated images 750. The evaluation output may be provided to the generator network as feedback data to train the generator network.

FIG. 7D depicts an example image comparison between a target image and a generated image from a GAN and an SLGAN according to example aspects of the present disclosure. More specifically, FIG. 7D depicts a set of images 760 for comparison, for instance, by the discriminator network in a GAN or SLGAN. The set of images 760 includes a target image 762, a GAN generated image 764, and a SLGAN generated image 766. As depicted, the target image 762 may be, for example, an image of at least a portion of a semiconductor workpiece. Additionally, as depicted, the SLGAN generated image 766 is substantially more similar to the target image 762 compared to the GAN generated image 764. Accordingly, aspects of the present disclosure directly contribute to the improved image output of the SLGAN generated image 766 compared to the GAN generated image 764. The SLGAN generated image 766 is similar to the target image 762 indicating a better trained overall model compared to the GAN and GAN generated image 764.

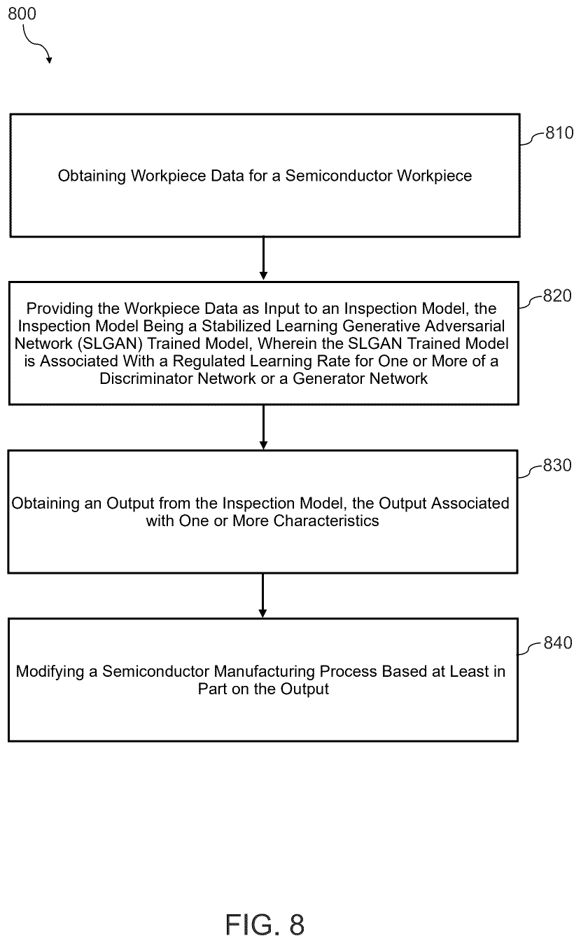

FIG. 8 depicts a flow diagram of an example method 800 according to example aspects of the present disclosure. FIG. 8 may be implemented by any of the systems provided herein. FIG. 8 depicts operations performed in a particular order for purposes of illustration and discussion. Those of ordinary skill in the art, using the disclosures provided herein, will understand that the operations of any of the methods provided herein may be adapted, expanded, omitted, rearranged, include steps not illustrated, or modified in various ways without deviating from the scope of the present disclosure.

At 810, the method 800 includes obtaining workpiece data for a semiconductor workpiece, such as a silicon carbide semiconductor wafer. In some embodiments, the workpiece data may be image data of at least a portion of the semiconductor workpiece, such as one or more images of a silicon carbide semiconductor wafer. Example image formats and images for the workpiece data include one or more of an optical surface microscopy image, photoluminescence (PL) microscopy image, cross-polarized light imaging image, x-ray topography image, or a scanning electron microscopy image. Additionally, in some embodiments, the workpiece data may be time series data or tabular data.

At 820, the method 800 includes providing the workpiece data to an inspection model. The inspection model may be a SLGAN trained model associated with a regulated learning rate for one or more of a discriminator network or generator network within the SLGAN. As examples, the SLGAN trained model may be one or more of an autoencoder model, image translation model, or feature detection model. In example embodiments including an autoencoder model, the autoencoder model may include an SLGAN trained encoding portion and/or decoding portion. In some embodiments, the SLGAN trained autoencoder model may include a decoding portion trained to generate a target image using, at least in part, the discriminator network of the SLGAN.

Across implementations, the SLGAN trained model may include a variety of characteristics relating to the SLGAN. For instance, the discriminator network associated with the SLGAN trained model may include a first learning rate that is different than a second learning rate of the generator network. In some embodiments, the first learning rate may be a regulated learning rate based, at least in part, on an adversarial ratio. In some embodiments, the adversarial ratio may be determined based on a ratio of a first loss of the generator network and a second loss of the discriminator network. For example, when the adversarial ratio may be greater than a threshold, such as 1, for a training epoch, one or more gradients for a next training period for the discriminator network may be frozen relative to one or more gradients for the next training period for the generator network. In some embodiments, the one or more gradients for the discriminator network may remain frozen until the adversarial ratio is less than or equal to the threshold.

At 830, the method 800 includes obtaining an output from the inspection model associated with one or more characteristics of the semiconductor workpiece. While not depicted, an additional operation of the method 800 may include determining one or more characteristics of the semiconductor workpiece associated with the workpiece data. The determination of one or more characteristics of the semiconductor workpiece may be based, at least in part, on the output of the inspection model. The output of the inspection model may vary based on the model present within the inspection model. For example, if the inspection model is a SLGAN-trained autoencoder model, the output may be an encoding from the encoding portion of the autoencoder model. The encoding may be indicative of a similarity or anomaly of the semiconductor workpiece. Additionally, in some embodiments, the encoding may be indicative of a feature or a feature distribution of the semiconductor workpiece. Example features or feature distributions that may be depicted in the output of the inspection model, regardless the internal models, include a threading edge dislocation, basal plan dislocation, super screw dislocation, micropipe, mixed dislocation, hexagonal void, stacking fault, or scratch.

In example embodiments including a feature detection model as the SLGAN-trained inspection model, the output may be a feature detection output including a target image with one or more pixels associated with a feature or feature distribution. Additionally, in some embodiments, the feature detection output may include data indicative of one or more locations of the feature or feature distribution, classification of the feature or feature distribution, size of the feature or feature distribution, or shape of the feature or feature distribution.

In example embodiments including an image translation output as the SLGAN-trained inspection model, the output may include an image translation output that provides a second image that is different from the image data of the workpiece provided as input. For instance, the image translation output may include additional information pertaining to the objects or features present in the image data as opposed to what is provided as input.

At 840, the method 800 includes modifying a semiconductor manufacturing process based at least in part on the output. For instance, the output may be used to determine when to keep and/or discard certain workpieces. The output may be used, for instance, to identify certain workpieces for different manufacturing operations (e.g., to address certain feature distributions associated with the encodings). The different manufacturing operations may include, for instance, grinding, lapping, polishing, or treatment process. The output may be used to identify errors or other anomalies in prior manufacturing operation(s) (e.g., crystal growth, wafer separation of boules, surface processing (e.g., grinding, lapping, polishing). The prior manufacturing operation(s) may be modified to reduce future anomalies on semiconductor workpieces. The manufacturing process or the fabrication process may include a workpiece fabrication process (e.g., fabricating semiconductor workpieces, such as silicon carbide semiconductor wafers) and/or one or more stages of semiconductor device fabrication o'f semiconductor workpieces.

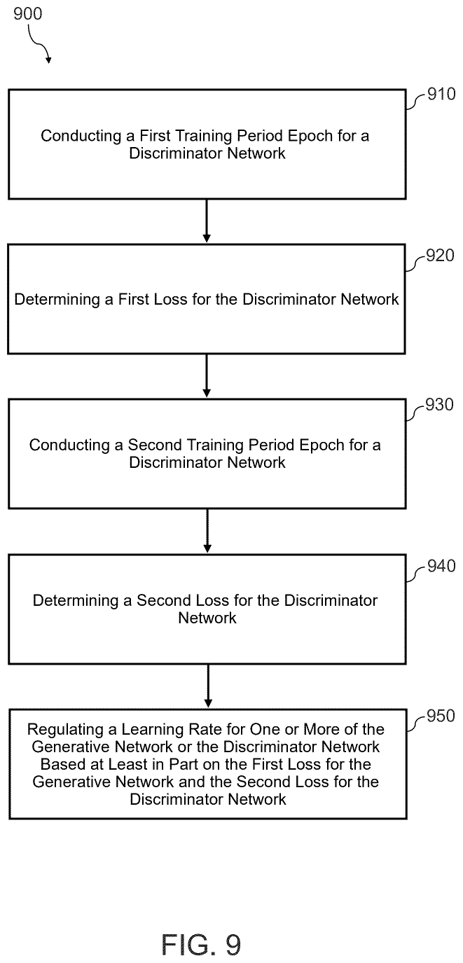

FIG. 9 depicts a flow diagram of an example method 900 according to example aspects of the present disclosure. FIG. 9 may be implemented by any of the systems provided herein. FIG. 9 depicts operations performed in a particular order for purposes of illustration and discussion. Those of ordinary skill in the art, using the disclosures provided herein, will understand that the operations of any of the methods provided herein may be adapted, expanded, omitted, rearranged, include steps not illustrated, or modified in various ways without deviating from the scope of the present disclosure.

At 910, the method 900 includes conducting a first training epoch for a generator network. In some embodiments, the first training epoch may be performed in parallel with a second training epoch for a discriminator network.

At 920, the method 900 includes determining a first loss for the generator network. For example, the mean absolute error of the generator network output compared to a target image may be determined as a loss associated with the generator network. In some embodiments, the mean absolute error may be multiplied by a lambda factor to scale the error appropriately for further processing.

At 930, the method 900 includes conducting a second training epoch for a discriminator network. In some embodiments, the second training epoch may be performed in parallel with the first training epoch for the generator network.

At 940, the method 900 includes determining a second loss for the discriminator network. As an example, the second loss associated with the discriminator network may be a sigmoid cross entropy of the output from the discriminator network compared to an array of 1's.

At 950, the method 900 includes regulating a learning rate for one or more of the generative network or the discriminator network based at least in part on the first loss for the generative network and the second loss for the discriminator network. In some examples, an adversarial ratio may be determined using the first loss and the second loss. For instance, the adversarial ratio may be determined based, at least in part, on a ratio of the first loss to the second loss. In some embodiments, the adversarial ratio may be used to regulate the learning rate of either the generator network or the discriminator network. To regulate the learning rate of either the generator network or the discriminator network, the adversarial ratio may be compared to a threshold value (e.g., threshold), such as about 1.0. In some embodiments, if the adversarial ratio exceeds the threshold, one or more parameters of either the discriminator network or generator network may be fixed for a next training period. In some embodiments, the parameters may be fixed until the adversarial ratio is equal to or falls below the threshold. In some example implementations of the adversarial ratio, the learning rate of either the generator network or the discriminator network may be regulated based on a function mapping or stochastic mapping of the adversarial ratio.

In some embodiments, the generative adversarial network trained via method 900 may be used to provide a machine-learned model for processing images of semiconductor workpieces. For example, processing images of silicon carbide semiconductor wafers, such as during manufacturing processes.

FIG. 10 depicts a block diagram of an example computing system 1000 that can be used to implement systems and methods according to example embodiments of the present disclosure. The system 1000 includes a computing system 1002 and a training computing system 1050 that are communicatively coupled over a network 1080.

The computing system 1002 can include any type of computing device (e.g., classical and/or quantum computing device). The computing system 1002 includes one or more processors 1012 and a memory 1014. The one or more processors 1012 can be any suitable processing device (e.g., a processor core, a microprocessor, CPU, GPU, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 (e.g., parameters, input data, etc.) and instructions 1018 which are executed by the processor 1012 to cause the computing system 1002 to perform operations. In some implementations, the computing system 1002 can store or include one or more machine-learned models 1020 (e.g., autoencoders, machine-learned encoding models, etc.) as described herein.

The computing system 1002 can train the machine-learned model(s) 1020 via interaction with the training computing system 1050 that is communicatively coupled over the network 1080. The training computing system 1050 can be separate from the computing system 1002 or can be a portion of the computing system 1002.

The training computing system 1050 includes one or more processors 1052 and a memory 1054. The one or more processors 1052 can be any suitable processing device (e.g., a processor core, a microprocessor, CPU, GPU, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations. In some implementations, the training computing system 1050 includes or is otherwise implemented by one or more server computing devices.

The training computing system 1050 can include a model trainer 1060 that trains the machine-learned model(s) 1020 using various training or learning techniques, such as, for example, backwards propagation of errors. In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the machine-learned model(s) 1020 based on a set of training data 1062. The training data 1062 can include, for example, input data corresponding to a plurality of semiconductor workpieces workpiece images, time series data, tabular data, etc.

The model trainer 1060 includes computer logic utilized to provide desired functionality. The model trainer 1060 can be implemented in hardware, firmware, and/or software controlling a general purpose processor. For example, in some implementations, the model trainer 1060 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 10 illustrates one example computing system that can be used to implement example aspects of the present disclosure. Other computing systems can be used as well. For example, in some implementations, the computing system 1002 can include the model trainer 1060 and the training data 1062. In such implementations, the model(s) 1020 can be both trained and used locally at the computing system 1002.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Example aspects of the present disclosure are set forth below. Any of the below features or examples may be used in combination with any of the embodiments or features provided in the present disclosure.

One example aspect is directed to a method. The method includes obtaining workpiece data for a semiconductor workpiece. The method includes providing the workpiece data as input to an inspection model, the inspection model being a stabilized learning generative adversarial network (SLGAN) trained model, wherein the SLGAN trained model is associated with a regulated learning rate for one or more of a discriminator network or a generator network. The method also includes obtaining an output from the inspection model, the output associated with one or more characteristics of the semiconductor workpiece.

In some implementations, the inspection model includes a machine-learned autoencoder model, the machine-learned autoencoder model comprising an encoding portion and a decoding portion.

In some implementations of the example method, the decoding portion of the autoencoder model generates a target image, wherein the decoding portion of the autoencoder is trained at least in part using the discriminator network.

In some implementations of the example method, the output includes an encoding from the encoding portion of the machine-learned autoencoder model.

In some implementations of the example method, the encoding is indicative of a similarity of the semiconductor workpiece or an anomaly of the semiconductor workpiece.

In some implementations of the example method, the encoding is indicative of a feature or a feature distribution of the semiconductor workpiece.

In some implementations of the example method, the feature is one or more of a threading edge dislocation, basal plan dislocation, super screw dislocation, micropipe, mixed dislocation, hexagonal void, stacking fault, or scratch.

In some implementations of the example method, the workpiece data includes image data of at least a portion of the semiconductor workpiece.

In some implementations of the example method, the image data includes one or more of an optical surface microscopy image, photoluminescence (PL) microscopy image, cross-polarized light imaging image, x-ray topography image, or a scanning electron microscopy image.

In some implementations of the example method, the output is a feature detection output from the inspection model.

In some implementations of the example method, the feature detection output includes a target image, the target image comprising one or more pixels associated with a feature or feature distribution.

In some implementations of the example method, the feature detection output includes data indicative of one or more locations of the feature or feature distribution, classification of the feature or feature distribution, size of the feature or feature distribution, or shape of the feature or feature distribution.

In some implementations of the example method, the output is an image translation output providing second image data that is different from the image data of at least a portion of the workpiece.

In some implementations of the example method, the workpiece data is time series data.

In some implementations of the example method, the workpiece data is tabular data.

In some implementations of the example method, the discriminator network has a first learning rate that is different than a second learning rate of the generator network.

In some implementations of the example method, the first learning rate of the discriminator network is a regulated learning rate based at least in part on an adversarial ratio, the adversarial ratio determined based on a ratio of a first loss of the generator network to a second loss of the discriminator network.

In some implementations of the example method, when the adversarial ratio is greater than a threshold for a training epoch, one or more gradients for a next training period for the discriminator network are frozen relative to one or more gradients for the next training period for the generator network.

In some implementations of the example method, the threshold is about 1.0.

In some implementations of the example method, the one or more gradients for the discriminator network remain frozen until the adversarial ratio is less than or equal to the threshold.

In some implementations of the example method, the semiconductor workpiece includes a silicon carbide semiconductor wafer.

In some implementations of the example method, the method includes determining one or more characteristics of the semiconductor workpiece based at least in part on the output.

In some implementations of the example method, the method includes modifying a semiconductor manufacturing process based at least in part on the output.

Another example aspect of the present disclosure is directed to a method. The method includes conducting a first training epoch for a generative network and determining a first loss for the generative network. The method includes conducting a second training epoch for a discriminator network and determining a second loss for the discriminator network. The method includes regulating a learning rate for one or more of the generative network or the discriminator network based at least in part on the first loss for the generative network and the second loss for the discriminator network.

In some implementations of the example method, the method includes determining an adversarial ratio for the generative adversarial network based at least in part on the first loss and the second loss.

In some implementations of the example method, the adversarial ratio is determined based at least in part on a ratio of the first loss to the second loss.

In some implementations of the example method, regulating a learning rate includes comparing the adversarial ratio to a threshold.

In some implementations of the example method, regulating a learning rate includes holding parameters fixed for a next training epoch for one or more of the discriminator network or the generator network when the adversarial ratio exceeds the threshold.

In some implementations of the example method, the threshold is about 1.

In some implementations of the example method, regulating a learning rate includes updating parameters for the next training epoch for one or more of the discriminator network or the generator network when the adversarial ratio is less than or equal to the threshold.

In some implementations of the example method, regulating a learning rate includes regulating the learning rate based on a function mapping of the adversarial ratio.

In some implementations of the example method, regulating a learning rate includes regulating the learning rate based on a stochastic mapping of the adversarial ratio.

In some implementations of the example method, wherein regulating a learning rate comprises regulating a learning rate of the discriminator network.

In some implementations of the example method, regulating a learning rate includes regulating a learning rate of the generator network.

In some implementations of the example method, the generative adversarial network is implemented to provide a machine-learned model for processing image data of at least a portion of a semiconductor workpiece.

In some implementations of the example method, the semiconductor workpiece includes a silicon carbide semiconductor wafer.

Another example aspect of the present disclosure is directed to a system. The system includes one or more imaging devices configured to capture image data of at least a portion of the semiconductor workpiece and processing circuitry configured to perform operations. The operations may include providing workpiece data as input to an inspection model, the inspection model being a generative adversarial network (GAN) trained model the GAN trained model is associated with a regulated learning rate for one or more of a discriminator network or a generator network. The operations may also include obtaining an output from the inspection model, the output associated with one or more characteristics of the semiconductor workpiece.

In some implementations of the example system, the one or more imaging devices comprise one or more of a PL microscope, an x-ray topographic imaging source, a cross-polarized light imaging source, an optical camera, or a scanning electron microscope.

In some implementations of the example system, the inspection model includes a machine-learned autoencoder model, the machine-learned autoencoder model comprising an encoding portion and a decoding portion.

In some implementations of the example system, the decoding portion of the autoencoder model generates a target image, wherein the decoding portion of the autoencoder is trained at least in part using the discriminator network.

In some implementations of the example system, the output includes an encoding from the encoding portion of the machine-learned autoencoder model.

In some implementations of the example system, the encoding is indicative of a similarity of the semiconductor workpiece or an anomaly of the semiconductor workpiece.

In some implementations of the example system, the encoding is indicative of a feature or a feature distribution of the semiconductor workpiece.

In some implementations of the example system, the feature is one or more of a threading edge dislocation, basal plan dislocation, super screw dislocation, micropipe, mixed dislocation, hexagonal void, stacking fault, or scratch.

In some implementations of the example system, the workpiece data includes image data of at least a portion of the semiconductor workpiece.

In some implementations of the example system, the image data includes one or more of an optical surface microscopy image, photoluminescence (PL) microscopy image, cross-polarized light imaging image, x-ray topography image, or a scanning electron microscopy image.

In some implementations of the example system, the output is a feature detection output from the inspection model.

In some implementations of the example system, the feature detection output includes a target image, the target image comprising one or more pixels associated with a feature or feature distribution.

In some implementations of the example system, the feature detection output includes data indicative of one or more locations of the feature or feature distribution, classification of the feature or feature distribution, size of the feature or feature distribution, or shape of the feature or feature distribution.

In some implementations of the example system, the output is an image translation output providing a second image that is different from the one or more images of the workpiece.

In some implementations of the example system, the discriminator network has a first learning rate that is different than a second learning rate of the generator network.

In some implementations of the example system, the first learning rate of the discriminator network is a regulated learning rate based at least in part on an adversarial ratio, the adversarial ratio determined based on a ratio of a first loss of the generator network to a second loss of the discriminator network.

In some implementations of the example system, when the adversarial ratio is greater than a threshold for a training period, one or more gradients for a next training period for the discriminator network are frozen relative to one or more gradients for the next training period for the generator network.

In some implementations of the example system, the threshold is about 1.0.

In some implementations of the example system, the one or more gradients for the discriminator network remain frozen until the adversarial ratio is less than or equal to the threshold.

In some implementations of the example system, the semiconductor workpiece includes a silicon carbide semiconductor wafer.

In some implementations of the example system, the GAN is a stabilized learning generative adversarial network (SLGAN).

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for inspecting semiconductor workpieces, the method comprising:
obtaining workpiece data for a semiconductor workpiece;
providing the workpiece data as input to an inspection model, the inspection model being a stabilized learning generative adversarial network (SLGAN) trained model, wherein the SLGAN trained model is associated with a regulated learning rate for one or more of a discriminator network or a generator network; and
obtaining an output from the inspection model, the output associated with one or more characteristics of the semiconductor workpiece.

2. The method of claim 1, wherein the inspection model comprises a machine-learned autoencoder model, the machine-learned autoencoder model comprising an encoding portion and a decoding portion, wherein the decoding portion of the autoencoder model generates a target image, wherein the decoding portion of the autoencoder is trained at least in part using the discriminator network.

3. The method of claim 2, wherein the output comprises an encoding from the encoding portion of the machine-learned autoencoder model.

4. The method of claim 3, wherein the encoding is indicative of a similarity of the semiconductor workpiece or an anomaly of the semiconductor workpiece.

5. The method of claim 3, wherein the encoding is indicative of a feature or a feature distribution of the semiconductor workpiece.

6. The method of claim 5, wherein the feature is one or more of a threading edge dislocation, basal plan dislocation, super screw dislocation, micropipe, mixed dislocation, hexagonal void, stacking fault, or scratch.

7. The method of claim 1, wherein the workpiece data comprises image data of at least a portion of the semiconductor workpiece.

8. The method of claim 7, wherein the image data comprises one or more of an optical surface microscopy image, photoluminescence (PL) microscopy image, cross-polarized light imaging image, x-ray topography image, or a scanning electron microscopy image.

9. The method of claim 1, wherein the output is a feature detection output from the inspection model, wherein the feature detection output comprises a target image, the target image comprising one or more pixels associated with a feature or feature distribution.

10. The method of claim 9, wherein the feature detection output comprises data indicative of one or more locations of the feature or feature distribution, classification of the feature or feature distribution, size of the feature or feature distribution, or shape of the feature or feature distribution.

11. The method of claim 1, wherein the output is an image translation output providing second image data that is different from the image data of at least a portion of the workpiece.

12. The method of claim 1, wherein the discriminator network has a first learning rate that is different than a second learning rate of the generator network.

13. The method of claim 12, wherein the first learning rate of the discriminator network is a regulated learning rate based at least in part on an adversarial ratio, the adversarial ratio determined based on a ratio of a first loss of the generator network to a second loss of the discriminator network.

14. The method of claim 13, wherein when the adversarial ratio is greater than a threshold for a training epoch, one or more gradients for a next training period for the discriminator network are frozen relative to one or more gradients for the next training period for the generator network.

15. The method of claim 14, wherein the one or more gradients for the discriminator network remain frozen until the adversarial ratio is less than or equal to the threshold.

16. The method of claim 1, wherein the semiconductor workpiece comprises a silicon carbide semiconductor wafer.

17. The method of claim 1, wherein the method comprises determining one or more characteristics of the semiconductor workpiece based at least in part on the output.

18. The method of claim 1, wherein the method comprises modifying a semiconductor manufacturing process based at least in part on the output.

19. A method for training a machine-learned model comprising a generative adversarial network, the method comprising:
conducting a first training epoch for a generative network;
determining a first loss for the generative network;
conducting a second training epoch for a discriminator network;
determining a second loss for the discriminator network; and
regulating a learning rate for one or more of the generative network or the discriminator network based at least in part on the first loss for the generative network and the second loss for the discriminator network.

20. A system for inspection of a semiconductor workpiece, the system comprising:
one or more imaging devices configured to capture image data of at least a portion of the semiconductor workpiece;
processing circuitry configured to perform operations, the operations comprising:
providing workpiece data as input to an inspection model, the inspection model being a generative adversarial network (GAN) trained model, wherein the GAN trained model is associated with a regulated learning rate for one or more of a discriminator network or a generator network; and
obtaining an output from the inspection model, the output associated with one or more characteristics of the semiconductor workpiece.
